(19) United States
(12) Patent Application Publication
(10) Pub. No.: US 2022/0185955 A1
(43) Pub. Date: Jun. 16, 2022

(54) PROCESS FOR PRODUCING POLYCARBONATE USING A REDUCED PHOSGENE EXCESS

(71) Applicant: Covestro Intellectual Property GmbH & Co. KG, Leverkusen (DE)

(72) Inventors: Rolf Bachmann, Bergisch Gladbach (DE); Volker Michele, Köln (DE); Jan Heijl, Lokeren (BE); Felix Cock, Wilrijk (BE)

(21) Appl. No.: 17/439,889

(22) PCT Filed: Mar. 30, 2020
(86) PCT No.: PCT/EP2020/058894

§ 371 Date: Sep. 16, 2021

(30) Foreign Application Priority Data
Apr. 3, 2019 (EP) 19166946.4

(51) Int. Cl. C08G 64/24; C08G 64/14

(52) U.S. Cl. CPC C08G 64/24; C08G 64/14

(57) ABSTRACT

The present invention relates to a process for producing polycarbonate according to a phase boundary process, from at least one dihydroxydiaryl alkane, phosgene, at least one catalyst and at least one chain terminator, the process allowing a reduction in the phosgene excess by a specific energy input during the dispersion of the aqueous and organic phases. The process also produces a polycarbonate with a low proportion of oligomers and a low proportion of Di-chain terminator carbonate.

### CROSS REFERENCE TO RELATED APPLICATIONS

This application is a U.S. national stage application, filed under 35 U.S.C. § 371, of International Application No. PCT/EP2020/058894, which was filed on Mar. 30, 2020, which claims priority to European Patent Application No. 19166946.4, which was filed on Apr. 3, 2019. The contents of each are hereby incorporated by reference into this specification.

### FIELD

The present invention relates to a process for producing polycarbonate by the interfacial process from at least one dihydroxydialkylalkane, phosgene, at least one catalyst and at least one chain terminator, wherein through a defined energy input for dispersing the aqueous and organic phase the process makes it possible to use a reduced phosgene excess. The process according to the invention simultaneously affords a polycarbonate having a low proportion of oligomers and a low proportion of di-chain terminator carbonate. The present invention also relates to the use of a defined energy input for dispersing the aqueous and organic phase in a process for producing polycarbonate by the interfacial process to reduce the phosgene excess.

### BACKGROUND

Polycarbonate production by the interfacial process has previously been described by Schnell “Chemistry and Physics of Polycarbonates”, Polymer Reviews, Volume 9, Interscience Publishers, New York, London, Sydney 1964, pp. 33-70; D. C. Prevorsek, B. T. Debona and Y. Kesten, Corporate Research Center, Allied Chemical Corporation, Morristown, N.J. 07960: “Synthesis of Poly(ester Carbonate) Copolymers” in Journal of Polymer Science, Polymer Chemistry Edition, Vol. 18, (1980)”; pp. 75-90, D. Freitag, U. Grigo, P. R. Müller, N. Nouverne′, BAYER AG, “Polycarbonates” in Encyclopedia of Polymer Science and Engineering, Volume 11, Second Edition, 1988, pp. 651-692 and finally by Dres U. Grigo, K Kircher and P. R. Müller “Polycarbonate” in Becker/Braun, Kunststoff Handbuch, Volume 3/1, Polycarbonates, Polyacetals, Polyesters, Cellulose esters, Crul Hanser Verlag Munich, Vienna 1992, pp. 118-145.

The interfacial process for producing polycarbonate is moreover also described, for example, in EP-A 0517044.

This generally comprises phosgenation of a disodium salt of a bisphenol or a mixture of different bisphenols initially charged in aqueous alkaline solution or suspension in the presence of an inert organic solvent or solvent mixture which forms a second organic phase in addition to the aqueous phase. The resulting oligocarbonates primarily present in the organic phase are subjected to condensation with the aid of suitable catalysts to afford high molecular weight polycarbonates dissolved in the organic phase, wherein the molecular weight may be controlled by suitable chain terminators (for example monofunctional phenols). The organic phase is finally separated and the polycarbonate is isolated therefrom by various processing steps.

Continuous processes for producing condensates using phosgene, —for example the production of aromatic polycarbonates or polyestercarbonates or oligomers thereof—by the interfacial process generally have the disadvantage that acceleration of the reaction and/or improving the phase separation requires more phosgene to be employed than is necessary for the product balance. The phosgene excess is then decomposed in the synthesis in the form of byproducts—for example additional common salt or alkali metal carbonate compounds. The continuous interfacial process for producing aromatic polycarbonates typically employs phosgene excesses of around 20 mol % based on the added diphenoxide (cf. D. Freitag, U. Grigo, P. R. Müller, N. Nouvertne′, BAYER AG, “Polycarbonates” in Encyclopedia of Polymer Science and Engineering, Volume 11, Second Edition, 1988, pages 651-692).

Reduction of the phosgene excess results in unwanted side effects such as poor separation of the dispersion after the last reaction step and thus elevated water contents in the organic solution and/or elevated residual monomers or chain terminator contents in the wastewater. Various methods of reducing the phosgene excess are discussed in the literature.

DE-A 2 725 967 teaches that it is advantageous for the phosgene yield of a process when the aqueous phase and the phosgene-containing organic phase are initially combined in a tube and subsequently introduced into a tank-type reactor.

In a continuous interfacial process for producing polycarbonates known from EP-A-304 691 an aqueous phase of diphenols and the particular amount of alkali metal hydroxide necessary is combined with a phosgene-containing organic phase in a tube using a static mixer. This process is capable of producing only prepolymers having a molecular weight of 4000 to 12 000 g/mol.

It is apparent from EP 0 520 272 B1 that a low phosgene excess may be achieved by splitting the flow of the BPA solution. Disadvantages of the method include the increased cost and complexity associated with metered addition of a second BPA stream.

DE 10 2008 012 613 A1 discloses a continuous process for producing polycarbonate, wherein a disperser is used for dispersing the organic and aqueous phase. It is described as advantageous here to produce an oil-in-water dispersion using the disperser. To this end this document generally discloses an energy input through the disperser of 2*e⁶ W/m³ to 5*e⁹ W/m³, preferably of 5*e⁶ W/m³ to 1*e⁹ W/m³. In fact, the examples in this document disclose an energy input of 1.2*e⁶ W/m³ and an oil-in-water dispersion is present. Since the energy input in the examples does not correspond to the generally disclosed ranges of energy input it is apparent that the generally disclosed energy inputs were incorrectly described in the description. This document focuses solely on reducing the phosgene content and does not provide much detail about the properties of the resulting polycarbonate. In particular, it mentions neither an oligomer proportion in the polycarbonate nor the content of di-chain terminator carbonate.

However, the properties of the resulting polycarbonate (PC) are affected by the oligomer proportion in the PC and also the proportion of the di-chain terminator carbonate. According to the invention the term “di-chain terminator carbonate” is understood as meaning a compound formed by reaction of two chain terminator molecules with phosgene to form a carbonate. The properties of the PC that are affected thereby include impact strength, glass transition temperature and behavior at elevated temperatures. In addition, low molecular weight compounds can lead to bleaching in the production of CDs. It should also be noted that the formation of a di-chain terminator carbonate causes chain terminator, which is actually required for the reaction and viscosity control thereof, to be lost. Thus, the higher the proportion of di-chain terminator in the polycarbonate, the higher the amount of chain terminator required, which is economically and ecologically less advantageous and impedes viscosity control in the process. It is therefore desirable to keep the content of di-chain terminator carbonate as low as possible.

The formation of di-chain terminator carbonate occurs through reaction of phosgene with the chain terminator. The chain terminator is therefore usually only added to the reaction system when the phosgene has been completely converted. This can be achieved, for example, by using a multi-stage process, which comprises a first stage of initially producing an oligomer which is subjected to further condensation in a 2nd stage or by adding the chain terminator very late in the process at high conversions, i.e. relatively large molecular weight increases, of the polycarbonate. However, according to conventional theory the content of oligomers in the resulting polycarbonate is increased when the chain terminator is added only at high conversions. It has been described that a high oligomer proportion leads to brittleness of low molecular weight PC, may result in molecular weight degradation as a result of transesterification during extrusion and reduces impact strength. In the prior art the process is therefore normally performed so as to strike a compromise between a high content of oligomers and a low content of di-chain terminator carbonate or else a low content of oligomers and a high content of di-chain terminator carbonate in the polycarbonate.

EP 0 408 924 A2 describes the production of low molecular weight polycarbonate having a narrow molecular weight distribution, i.e. a low oligomer proportion. In order to achieve such a narrow distribution this piece of prior art proposes a two-stage process in which a phosgene-free bischloroformate having a degree of polymerization of 0 to 6 is capped with phenol for example and subsequently with addition of a catalyst and a base the obtained capped bischloroformate is subjected to condensation. Here too, phenol is added to the bischloroformate solution as a chain terminator at a juncture when phosgene is no longer present in the solution. EP 0 289 826 A2 likewise relates to the production of polycarbonate with a small proportion of oligomers. This document also proceeds from a bischloroformate having a degree of polymerization of 0 to 6. According to example 2 this bischloroformate is produced in a reaction initially employing a large phosgene excess (739.3 mmol of phosgene to 250 mmol of bisphenol A). The unconverted proportion of phosgene is therefore subsequently decomposed by addition of NaOH. Only then is the chain terminator p-t-butylphenol added. This means that here too the chain terminator is added to the reaction system at a juncture when phosgene is no longer present.

EP 0 640 639 A2 describes a two-stage process comprising initially continuously reacting bisphenol A with phosgene in excess. This is followed by separation of the organic and aqueous phase in a further step, with further bisphenol A and NaOH then being added to the organic phase to convert any remaining phosgene. Only then is a catalyst and the chain terminator added.

All the above described cases initially employ an excess of phosgene which is then destroyed again. This is not economical because not all of the phosgene is utilized for the actual reaction. This is moreover unsustainable from an ecological perspective, since a previously manufactured product is destroyed “unused”. In addition, the described processes require production of a new solution after the production of the bischloroformate and this is associated with corresponding cost and complexity. This especially has the result that the described processes cannot readily be performed as a continuous process. This would require additional apparatuses also resistant to corrosion with additional residence times of a highly corrosive material.

### SUMMARY

It is accordingly an object of the present invention to provide a process for producing polycarbonate by the interfacial process, wherein at least one disadvantage of the prior art is improved. It is a particular object of the present invention to provide a process for producing polycarbonate by the interfacial process, wherein the phosgene excess may be reduced. It was moreover preferably simultaneously desirable to obtain a polycarbonate having a low oligomer proportion and thus a narrow molecular weight distribution. It was likewise preferably simultaneously desirable for the process to provide a polycarbonate having a low content of di-chain terminator carbonate. It is a particular object of the present invention to provide a process for producing polycarbonate by the interfacial process which affords a polycarbonate that simultaneously has a low proportion of oligomers and of di-chain terminator carbonate.

At least one, preferably all, of the abovementioned objects were achieved by the present invention. It has surprisingly been found that the use of a defined energy input in the dispersing of the aqueous and organic phase makes it possible to reduce the phosgene excess. This results in an economic saving since less excess phosgene is required. At the same time it has surprisingly been found that, as a result of the high phosgene conversion produced, the reactions of phosgenation of the at least one dihydroxydiarylalkane, of oligomerization and of hydrolysis can be separated. This preferably means that as a result of the high phosgene conversion the addition of the at least one chain terminator to the reaction system may be carried out earlier. This especially means that the addition of the chain terminator to the reaction system may also be carried out at a juncture when phosgene is still present in the reaction system. The chain terminator may therefore be introduced into the reaction system at a very early juncture. “Very early” is here understood as meaning that only oligomeric compounds from the reaction of at least one dihydroxydiarylalkane with the phosgene are present which on average have a degree of polymerization of at least one unit and at most five or six units. The resulting polycarbonate surprisingly has a low proportion of di-chain terminator carbonate although the chain terminator is introduced into a system containing phosgene. Simultaneously, the resulting polycarbonate has a narrow molecular weight distribution and thus a low oligomer proportion. The resulting polycarbonate therefore also has the above-described improved properties resulting from a low proportion of di-chain terminator carbonate and a low proportion of oligomers. The process according to the invention is more economical and more ecological than the processes described in the prior art. Firstly, the phosgene excess can be reduced with the process according to the invention. In addition, the amount of chain terminator required can be reduced since losses through formation of di-chain terminator carbonate are reduced.

### BRIEF DESCRIPTION OF DRAWINGS

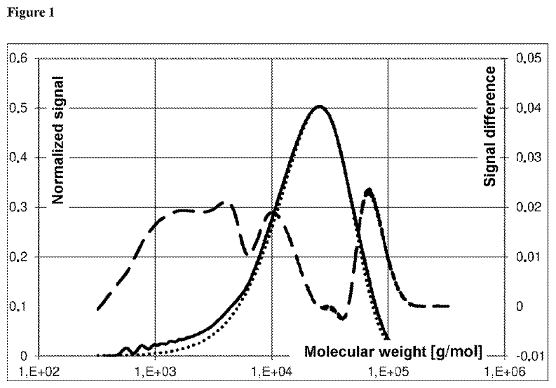

Information for FIG. 1:

Solid line: original GPC, normalized to area=1

Dotted line: Schulz Flory distribution adapted so maximum coincides with the maximum of the GPC

Dashed line: Difference between the two curves (solid and dotted line)

The oligomer fraction is obtained from the integral of the difference curve between 500-5000 g/mol

### DETAILED DESCRIPTION

The present invention therefore provides a process for producing polycarbonate by the interfacial process from at least one dihydroxydiarylalkane, phosgene, at least one catalyst and at least one chain terminator comprising the steps of
(a) generating a dispersion from an organic and an aqueous phase by continuously dispersing the organic phase in the aqueous phase or the aqueous phase in the organic phase in a disperser, wherein the organic phase contains at least one solvent suitable for the polycarbonate and at least a portion of the phosgene and the aqueous phase contains the at least one dihydroxydiarylalkane, water and 1.8 mol to 2.2 mol, preferably 1.95 mol to 2.05 mol, of aqueous alkali metal hydroxide solution per mol of dihydroxydiarylalkane,
(b) adding at least one chain terminator to the dispersion from step (a) and
(c) adding at least one catalyst to the mixture obtained from step (b),
which is characterized in that
the energy input by the disperser in step (a) is 2.5*e⁶ W/m³ to 5.0*e⁷ W/m³, preferably 3.0*e⁶ W/m³ to 4.0*e⁷ W/m³, particularly preferably from 1.0*e⁷ W/m³ to 3.5*e⁷ W/m³.

Those skilled in the art are capable of converting J/kg into W/m³ based on the density of a PC solution at 25° C. of 1.22 g/cm³. The terms homogenization and dispersion are known to those skilled in the art. The term “homogenization” is preferably understood as meaning that a state in which the concentrations of the individual components of the composition in any desired volume element of the aqueous or else the organic phase are substantially identical is sought and preferably attained. The term “substantially” is preferably understood as meaning a deviation in the concentration of the individual components of the composition in any desired volume element of not more than 5%, preferably not more than 3% and particularly preferably not more than 1%. In contrast to dispersion it is further preferred for homogenization that the phase interface between the aqueous and organic phase is as small as possible. Furthermore, the term “dispersion” is preferably understood as meaning the formation of an emulsion, preferably without the presence of an emulsifier, from the aqueous and the organic phase, wherein the aqueous and organic phase may also contain the further components for producing the polycarbonate. Examples of such an emulsion are the oil-in-water or water-in-oil dispersions. Homogenization preferably differs from dispersion in that for homogenization there is no concentration gradient of any dissolved substance in either of the phases and the phase interface between the phases is as small as possible.

According to the invention it has been found that the phosgene excess can be successfully reduced further only in certain ranges of energy input. A person skilled in the art is capable of calculating a corresponding energy input when a reactor is specified.

According to the invention the specified energy inputs are average values. This means that higher values or else lower values of energy input are preferably not excluded. These may optionally also occur only for a short term. According to the invention the average values are preferably formed over an entire reactor system. The energy input at relevant edge zones or else internals is therefore included in the calculation.

Dispersion of the organic phase in the aqueous phase or the aqueous phase in the organic phase using a disperser may produce an oil-in-water (ow) dispersion or a water-in-oil dispersion (wo), wherein oil is understood as meaning the organic phase. However, it is preferable according to the invention when process step (a) comprises producing a water-in-oil dispersion. This has been found to be advantageous for a low content of oligomers and di-chain terminator carbonate in the polycarbonate. The organic phase is preferably continuously dispersed into the aqueous phase using the disperser.

By definition an oil-in-water dispersion is one in which water forms the outer (continuous) phase and oil forms the inner (dispersed) phase, i.e. oil droplets are distributed in water. A water-in-oil dispersion is therefore one in which oil forms the outer phase and water forms the inner phase.

It is preferable when the process according to the invention is characterized in that the process comprises the step of one or more additions of an aqueous alkali metal hydroxide solution. The term “addition” is preferably understood as meaning an active step of additive addition. It may especially also be possible to initially dissolve the at least one dihydroxyarylalkane in an aqueous alkali metal hydroxide solution before it is supplied to the reaction system. According to the invention such an initial step is preferably not the addition of an aqueous alkali metal hydroxide solution. However, it is further preferable when after this initial step of dissolving the at least one dihydroxyarylalkane any addition of an aqueous alkali metal hydroxide solution (whether with the at least one dihydroxyarylalkane or not) is understood as constituting an addition of an aqueous alkali metal hydroxide solution.

This step of adding an aqueous alkali metal hydroxide solution is an exothermic reaction. According to the invention said step is preferably performed in a temperature range of −5° C. to 100° C., particularly preferably 15° C. to 80° C., very particularly preferably 25° C. to 65° C., wherein depending on the solvent or solvent mixture it may be performed under positive pressure. Different pressures may be used depending on the employed reactor. For example a pressure of 0.5 to 20 bar (absolute) may preferably be used.

It has proven particularly advantageous when the process according to the invention is characterized in that the adding of the at least one chain terminator to the reaction system of process step (b) is performed at a juncture prior to the first of the one or more additions of the aqueous alkali metal hydroxide solution.

It is initially clear to those skilled in the art that aqueous alkali metal hydroxide solution may in principle be added before addition of the at least one chain terminator. However, according to the invention it has been found that this amount must not be too high since otherwise the degree of polymerization of the reaction product R becomes too high. This means that before addition of the at least one chain terminator those skilled in the art can add aqueous alkali metal hydroxide solution only in an amount that still ensures that the preferences according to the invention in respect of the reaction product R are satisfied.

The process according to the invention can be utilized to reduce the phosgene excess. It is preferable when in process step (a) there is an excess of phosgene over the sum of the employed dihydroxydiarylalkanes of 3 to 20 mol %, preferably 4 to 10 mol %, particularly preferably of 5 to 9 mol %, very particularly preferably of 6 to 8 mol %. According to the invention mol % are calculated as follows: mol of phosgene/(mol sum of all phenolic OH groups/2). The sum of all phenolic groups is made up for example of the dihydroxydiarylalkane having 2 OH groups, the chain terminator having 1 OH group and/or optionally branching agents having for example 3 OH groups.

As described hereinabove, according to the invention the presence of an aqueous alkali metal hydroxide solution in step (a) is preferably not understood as meaning addition of an aqueous alkali metal hydroxide solution. This is the aqueous alkali metal hydroxide solution, preferably aqueous sodium hydroxide solution, used to dissolve the BPA in the aqueous phase. During the phosgenation step (a) it is preferable to provide as little free aqueous alkali metal hydroxide solution as possible to avoid hydrolysis of the phosgene to afford sodium carbonate (i.e. loss of phosgene). According to the invention step (a) therefore employs 1.80 mol to 2.20 mol, preferably 1.95 mol-2.05 mol, of aqueous alkali metal hydroxide solution per mol of dihydroxydiarylalkane.

The organic phase comprises one or more solvents.

Suitable solvents are aromatic and/or aliphatic chlorinated hydrocarbons, preferably dichloromethane, trichlorethylene, 1,1,1-trichloroethane, 1,1,2-trichloroethane and chlorobenzene and mixtures thereof. However, it is also possible to use aromatic hydrocarbons such as benzene, toluene, m-/p-/o-xylene or aromatic ethers such as anisole alone, in admixture, or in addition to or in admixture with chlorinated hydrocarbons; preference is given to dichloromethane and chlorobenzene and mixtures thereof. Another embodiment of the method according to the invention employs solvents which do not dissolve, but rather only swell, polycarbonate. It is therefore also possible to use non-solvents for polycarbonate in combination with solvents. Solvents soluble in the aqueous phase such as tetrahydrofuran, 1,3- or 1,4-dioxane or 1,3-dioxolane can then also be used as solvents if the solvent partner forms the second organic phase.

Suitable dihydroxydiarylalkanes—hereinabove and hereinbelow also referred to inter alia as diphenol—are those of general formula

HO—Z—OH

wherein Z is a divalent organic radical having 6 to 30 carbon atoms which contains one or more aromatic groups. Examples of such compounds employable in the process according to the invention are dihydroxydiarylalkanes such as hydroquinone, resorcinol, dihydroxydiphenyl, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, 4,4′-bis(hydroxyphenyl)diisopropylbenzenes, and the alkylated, ring-alkylated and ring-halogenated compounds thereof.

Preferred dihydroxydiarylalkanes are 4,4′-dihydroxydiphenyl, 2,2-bis(4-hydroxyphenyl)-1-phenylpropane, 1,1-bis(4-hydroxyphenyl)phenylethane, 2,2-bis(4-hydroxyphenyl)propane (bisphenol A (BPA)), 2,4-bis(4-hydroxyphenyl)-2-methylbutane, 1,3-bis[2-(4-hydroxyphenyl)-2-propyl]benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,3-bis[2-(3,5-dimethyl-4-hydroxyphenyl)-2-propyl]benzene, 1,1-bis(4-hydroxyphenyl)cyclohexyne and 1,1-bis(4-hydroxyphenyl)-3,3,5-trimethylcyclohexane (bisphenol TMC).

Particularly preferred dihydroxydiarylalkanes are 4,4′-dihydroxydiphenyl, 1,1-bis(4-hydroxyphenyl)phenylethane, 2,2-bis(4-hydroxyphenyl)propane (bisphenol A (BPA)), 2,2-bis(3,5-dimethyl-4-hydroxyphenyl)propane, 1,1-bis(4-hydroxyphenyl)cyclohexane and 1,1-bis(4-hydroxyphenyl)-3,3,5-trimethylcyclohexane (bisphenol TMC).

These and further suitable dihydroxydiarylalkanes are described, for example, in U.S. Pat. Nos. 2,999,835, 3,148,172 2,991,273, 3,271,367, 4,982,014 and 2,999,846, in the German laid-open specifications DE-A 1 570 703, DE-A 2 063 050, DE-A 2 036 052, DE-A 2 211 956 and DE-A 3 832 396, in the French patent specification FR-A 1 561 518, in the monograph “H. Schnell, Chemistry and Physics of Polycarbonates, Interscience Publishers, New York 1964, p. 28 ff.; p. 102 ff.”, and in “D. G. Legrand, J. T. Bendler, Handbook of Polycarbonate Science and Technology, Marcel Dekker New York 2000, pp. 72ff.”.

According to the invention, polycarbonates are understood as meaning both homopolycarbonates and copolycarbonates. In the case of production according to the invention of homopolycarbonates only one dihydroxydiarylalkane is employed and in the case of production according to the invention of copolycarbonates two or more dihydroxydiarylalkanes are employed, wherein it will be appreciated that the employed dihydroxydiarylalkanes, as well as all other chemicals and auxiliaries added to the synthesis, may be contaminated with impurities deriving from their own synthesis, handling and storage, though it is desirable to employ the cleanest possible raw materials.

In the context of the invention aqueous alkali metal hydroxide solution is preferably to be understood as meaning aqueous sodium hydroxide solution, potassium hydroxide solution or mixtures thereof, particularly preferably aqueous sodium hydroxide solution.

The aqueous phase in the interfacial process for producing the polycarbonate contains aqueous alkali metal hydroxide solution, one or more dihydroxydiarylalkanes and water, wherein the concentration of this aqueous solution in terms of the sum of the dihydroxydiarylalkanes calculated not as alkali metal salts but rather as free dihydroxydiarylalkane is preferably between 1% and 30% by weight, particularly preferably between 3% and 25% by weight, very particularly preferably 15% to 18% by weight based on the total weight of the aqueous phase. The alkali metal hydroxide used to dissolve the dihydroxydiarylalkanes, for example sodium or potassium hydroxide, may be used in solid form or as the corresponding aqueous alkali metal hydroxide solution. The concentration of the aqueous alkali metal hydroxide solution is determined by the target concentration of the desired dihydroxydiarylalkane solution but is generally between 5% and 25% by weight, preferably 5% and 10% by weight, based on 100% by weight of aqueous alkali metal hydroxide solution or is more concentrated and subsequently diluted with water. The process with subsequent dilution employs optionally temperature controlled aqueous alkali metal hydroxide solutions having concentrations between 15% and 75% by weight, preferably 25% and 55% by weight. The alkali metal content per mol of dihydroxydiarylalkane depends on the structure of the dihydroxydiarylalkane but is generally from 1.5 mol alkali metal/mol dihydroxydiarylalkane to 2.5 mol alkali metal/mol dihydroxydiarylalkane, preferably from 1.8 to 2.2 mol alkali metal/mol dihydroxydiarylalkane and in a particularly preferred case where bisphenol A is used as the sole dihydroxydiarylalkane from 1.85 to 2.15 mol of alkali metal, very particularly preferably 2.00 mol of alkali metal. If more than one dihydroxydiarylalkane is used these may be dissolved together. However, since the solubility of dihydroxydiarylalkanes depends very strongly on the employed alkali metal amount it may be advantageous to have not one solution comprising two dihydroxydiarylalkanes but rather two solutions each comprising one dihydroxydiarylalkane dissolved in a suitable aqueous alkali metal hydroxide solution which are then metered in separately so as to form the correct mixing ratio. It may moreover be advantageous to dissolve the dihydroxydiarylalkane(s) not in aqueous alkali metal hydroxide solution but rather in diluted dihydroxydiarylalkane solution containing additional alkali metal. The dissolution processes may proceed from solid dihydroxydiarylalkanes, usually in flake or prill form, or else from molten dihydroxydiarylalkanes. The employed alkali metal hydroxide/aqueous alkali metal hydroxide solution may, in the case of sodium hydroxide or aqueous sodium hydroxide solution, have been produced, for example, by the amalgam process or the so-called membrane process. Both methods have long been used and are familiar to those skilled in the art. In the case of aqueous sodium hydroxide solution it is preferable to use that produced by the membrane process.

In such an aqueous solution and/or the aqueous phase the dihydroxydiarylalkane(s) are completely or partially in the form of the corresponding alkali metal salts/dialkali metal salts.

An optionally practiced metering of dihydroxydiarylalkane(s) after or during the phosgene introduction can be carried out for as long as phosgene or its direct derivatives, the chlorocarboxylic esters are present in the reaction solution.

The organic phase of step (a) comprises not only the at least one solvent but also at least phosgene. The organic phase comprises all or part of the required phosgene before production of the mixture. The organic phase preferably contains the total phosgene required including the phosgene excess used before production of the mixture. The introduction of the phosgene into the organic phase can be effected in gaseous form or in liquid form.

The addition of at least one chain terminator to the reaction system of step (a) is effected in step (b). The reaction system of step (a) preferably comprises unconverted phosgene. The at least one chain terminator is generally monofunctional. The at least one chain terminator is preferably selected from the group consisting of phenol, alkylphenols and chlorocarbonic acid esters thereof or acid chlorides of monocarboxylic acids, preferably from phenol, tert-butylphenol and iso-octylphenol, cumylphenol. Any desired mixtures of the recited chain terminators may be employed.

In a particularly preferred embodiment of the process according to the invention phenol is used as the chain terminator. It is preferable to employ the phenol in step (b) in the form of a solution comprising at least one organic solvent and the phenol in a concentration of 5% to 40% by weight, preferably 10% to 25% by weight. In this embodiment the aqueous phase is preferably adjusted to a pH of 11.3 to 11.6 at the end of the reaction (i.e. in step (b)). The addition of the phenol and the adjustment of the pH to 11.3 to 11.6 is preferably carried out before addition of the catalyst.

In another preferred embodiment of the process according to the invention p-tert-butylphenol is used as the chain terminator. It is preferable to employ the p-tert-butylphenol in step (b) in the form of a solution comprising at least one organic solvent and the p-tert-butylphenol in a concentration of 2% to 25% by weight, preferably 3% to 15% by weight. In this embodiment the aqueous phase is preferably adjusted to a pH of 11.5 to 11.8 at the end of the reaction (i.e. in step (b)). The addition of the p-tert-butylphenol and the adjustment of the pH to 11.5 to 11.8 is preferably carried out before addition of the catalyst.

In step (b) one or more branching agents or branching mixtures may optionally be added to the synthesis. However, such branching agents are preferably added before the chain terminator(s). Such branching agents are very particularly preferably added in process step (a) with the aqueous phase together with the solution of the at least one dihydroxydiarylalkane. Employed branching agents include for example trisphenols, quaterphenols, chlorides of tri- or tetracarboxylic acids or else mixtures of the polyphenols or of the acid chlorides.

Examples of compounds suitable as branching agents having three, or more than three, phenolic hydroxyl groups are phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]propane 2,4-bis(4-hydroxyphenyl-2-isopropyl)phenol, tetra(4-hydroxyphenyl)methane.

Examples of other trifunctional compounds suitable as branching agents include 2,4-dihydroxybenzoic acid, trimesic acid, cyanuryl chloride and 3,3-bis(3-methyl-4-hydroxyphenyl)-2-oxo-2,3-dihydroindole. Particularly preferred branching agents are 3,3-bis(3-methyl-4-hydroxyphenyl)-2-oxo-2,3-dihydroindole and 1,1,1-tri(4-hydroxyphenyl)ethane.

It has proven advantageous when the at least one addition of the aqueous alkali metal hydroxide solution is carried out when the dispersion is still an oil-in-water dispersion. The addition of aqueous alkali metal hydroxide solution, which is aqueous, to a water-in-oil emulsion generally results in a non-ideal molecular weight distribution. Since the at least one chain terminator is preferably added beforehand, this also means that the at least one chain terminator is preferably also added to an oil-in-water dispersion. According to the invention it is possible for the dispersion to switch from water-in-oil to an oil-in-water dispersion during the process.

The process according to the invention further comprises the step of

(c) adding at least one catalyst to the mixture obtained from step (b).

It is preferable when the at least one catalyst is selected from the group consisting of a tertiary amine, an organophosphine and any desired mixtures. The at least one catalyst is very particularly preferably a tertiary amine or a mixture of at least two tertiary amines.

Tertiary amines are likewise preferably triethylamine, tributylamine, trioctylamine, N-ethylpiperidine, N-methylpiperidine or N-i/n-propylpiperidine; these compounds are described in the literature as typical interfacial catalysts, are commercially available and are well known to those skilled in the art. The catalysts may also be added to the synthesis individually, in admixture or else simultaneously or successively, optionally also before the phosgenation, though metered additions after phosgene introduction are preferred. The metered addition of the catalyst or of the catalysts may be effected in pure form, in an inert solvent, preferably the solvent or one of the solvents of the organic phase in the polycarbonate synthesis, or else as an aqueous solution. When using tertiary amines as catalyst the metered addition thereof may be effected for example in aqueous solution as ammonium salts thereof with acids, preferably mineral acids, in particular hydrochloric acid. It will be appreciated that when using two or more catalysts or when performing metered addition of subamounts of the total catalyst amount different modes of metered addition may be undertaken at different locations or at different junctures. The total amount of employed catalysts is preferably between 0.001 to 10 mol %, preferably 0.01 to 8 mol %, particularly preferably 0.05 to 5 mol %, based on moles of employed dihydroxydiarylalkanes.

Dispersers are in principle known to those skilled in the art. According to the invention it is preferable when at least one nozzle, pipe baffle, static mixer, pump and/or jet disperser is used as the disperser in process step (a). Preference is especially given to jet dispersers which allow for a preferred direction of the metered addition. Dispersers suitable in the context of the invention are described for example in EP-A 1 368 407 and EP-A 1 599 520.

Suitable nozzles are, for example, slot nozzles, annular slot nozzles, orifice nozzles, Lefos nozzles or smooth-jet nozzles. Those skilled in the art can choose the opening of the nozzle such as to result in the energy inputs according to the invention using their knowledge of the art.

The pressure to be used may preferably be 0.001 to 1 MPa, particularly preferably 0.001 to 0.5 MPa.

Preferred embodiments of the process according to the invention employ dispersers in which the organic and the aqueous phase are preferably supplied to a predisperser separately and/or only one of the phases is supplied to a predisperser by a single pump in each case. The pressure of these pumps is preferably not more than 2.5 MPa, preferably from 0.001 to 0.5 MPa. The predisperser preferably produces a water-in-oil dispersion.

Nozzles suitable as the predisperser include any desired nozzles such as for example slot nozzles, annular slot nozzles, orifice nozzles, Lefos nozzles or smooth-jet nozzles and jet dispersers. Nozzles suitable as homogenization nozzles likewise include any desired nozzles such as for example slot nozzles, annular slot nozzles, orifice nozzles, Lefos nozzles or smooth-jet nozzles and jet dispersers.

In a further preferred embodiment rotary dispersers as described in EP B1 2090605 may be used. The predisperser is then preferably followed by the disperser employed according to the invention. The energy input defined according to the invention is effected here.

The process according to the invention is performed as a continuous process. The overall reaction, i.e. reaction and further condensation, may therefore be carried out in stirred tanks, tubular reactors, pumped-circulation reactors or stirred tank cascades or combinations thereof, wherein the use of the abovementioned mixing apparatuses ensures that the aqueous and organic phase ideally undergo demixing only when the synthesis mixture has fully reacted, i.e. no hydrolysable chlorine of phosgene or chlorocarbonic esters remains present. In a preferred embodiment of the process according to the invention the disperser in process step (a) is followed by a flow reactor. Such an arrangement makes it possible to particularly advantageously realize an extremely short residence time of less than 0.5 seconds of the mixture passed through. In a further preferred embodiment of the process according to the invention a pumped-circulation reactor then follows.

The employed pumped-circulation reactor is preferably a tank reactor having a pumped-circulation loop and a pumped-circulation rate of 5 to 15 times, preferably 7.5 to 10 times, the throughput. The residence time of the reaction mixture in this reactor is preferably 2 to 20 minutes, particularly preferably 2 to 5 minutes.

In a further preferred embodiment of the process according to the invention the pump-circulation reactor is followed by further dwell reactors. The residence time of the reaction mixture in the pumped-circulation reactor and the dwell reactors is preferably 2 to 20 minutes in each case.

In a preferred aspect of the invention the continuous process according to the invention is in all above-described embodiments and preferences characterized in that in process step (b) the at least one chain terminator is introduced into the reaction system comprising at least the at least one dihydroxydiarylalkane, phosgene and the reaction product R of the at least one dihydroxydiarylalkane and phosgene at a juncture at which the reaction product R is a mixture of compounds and these compounds on average have a degree of polymerization of at least one unit and at most six units formed from the at least one dihydroxydiarylalkane by the reaction with the phosgene. At the juncture of addition of the at least one chain terminator the reaction system comprises at least the at least one dihydroxydiarylalkane, phosgene and the reaction product R. Said system may at this juncture also contain at least one catalyst. However, this is not preferred. It is preferable when at the juncture of addition of the at least one chain terminator the reaction system comprises, very particularly preferably consists of, at least one dihydroxydiarylalkane, phosgene, the reaction product R and the solvents necessary for performing the interfacial process Said solvents are preferably an aqueous alkali metal hydroxide solution and at least one organic solvent.

As described hereinabove it is preferable according to the invention to effect “early” introduction of the chain terminator into the reaction system. According to the invention the juncture is defined in that the reaction product R is a mixture of compounds, wherein these compounds on average have a degree of polymerization of at least one unit and at most six units.

The term “degree of polymerization” is known to those skilled in the art. The degree of polymerization preferably indicates the number of units in the oligomeric reaction product R formed from the at least one dihydroxydiarylalkane by the reaction with the phosgene. The reported degree of polymerization is an average value. This is because the degree of polymerization is preferably determined on the basis of the number-average molar mass Mₙ. This comprises forming the quotient of Mₙ of the oligomer/polymer and the molar mass of the repeating unit (the unit formed from the at least one dihydroxydiarylalkane by the reaction with the phosgene; preferably the unit represented by the general chemical formula (I)). The number-average molar mass Mₙ is in turn according to the invention preferably determined by gel permeation chromatography (GPC). Said mass is particularly preferably determined by GPC according to DIN 55672-1: 2016-03 calibrated against bisphenol A polycarbonate standards with dichloromethane as eluent. According to the invention it is very particularly preferable when the molecular weights Mw (weight average), Mn (number average) and Mv (viscosity average) are determined by means of gel permeation chromatography based on DIN 55672-1: 2007-08 using a BPA polycarbonate calibration. Calibration was carried out using linear polycarbonates of known molar mass distribution (for example from PSS Polymer Standards Service GmbH, Germany). Method 2301-0257502-09D (2009 German language version) from Currenta GmbH & Co. OHG, Leverkusen was used. Dichloromethane was used as eluent. The column combination consisted of crosslinked styrene-divinylbenzene resins. The GPC may comprise one or more serially connected commercially available GPC columns for size exclusion chromatography selected such that sufficient separation of the molar masses of polymers, in particular of aromatic polycarbonates having weight-average molar masses Mw of 2000 to 100 000 g/mol, is possible. The analytical columns typically have a diameter of 7.5 mm and a length of 300 mm. The particle sizes of the column material are in the range from 3 μm to 20 μm. The concentration of the analyzed solutions was 0.2% by weight. The flow rate was adjusted to 1.0 ml/min, the temperature of the solution was 30° C. Detection was effected using a refractive index (RI) detector.

The process according to the invention is preferably further characterized in that the compounds of the mixture of the reaction product R are represented by the general chemical formula (I):

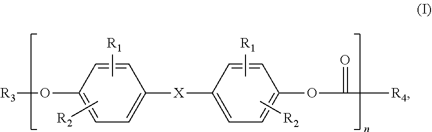

in which
R₁ and R₂ independently of one another represent H, C1- to C18-alkyl, C1- to C18-alkoxy, halogen such as Cl or Br or in each case optionally substituted aryl or aralkyl, preferably H or C1- to C12-alkyl, particularly preferably H or C1- to C8-alkyl and very particularly preferably H or methyl,
R₃ represents H, (C═O)—Cl or (C═O)—OH,
R₄ represents OH or Cl,
X represents a single bond, —SO₂—, —CO—, —O—, —S—, C1- to C6-alkylene, C2- to C5-alkylidene or C5- to C6-cycloalkylidene which may be substituted by C1- to C6-alkyl, preferably methyl or ethyl, or else represents C6- to C12-arylene which may optionally be fused to further aromatic rings containing heteroatoms and
n represents the degree of polymerization and thus the number of units formed from the at least one dihydroxydiarylalkane by the reaction with the phosgene and on average may have a value of 1 to 6, preferably 1 to 5, particularly preferably 1 to 4, very particularly 1 to 3.

According to the invention it is likewise possible that the reaction product R may furthermore be in partially hydrolyzed form. The chlorine of the chloroformate group is eliminated to form carbonate. However, according to the invention this side reaction is unwanted. This means that the reaction product R is a mixture comprising such a hydrolyzed product. However, this is less preferred. The compounds of the mixture of the reaction product R are preferably represented by general chemical formula (I) in which
R₁ and R₂ each independently of one another represent H or C1 to C12 alkyl, particularly preferably H or C1- to C8-alkyl and very particularly preferably H or methyl,
R₃ represents H or (C═O)—Cl,
R₄ represents Cl,
X represents a single bond, C1- to C6-alkylene, C2- to C5-alkylidene or C5- to C6-cycloalkylidene which may be substituted by methyl or ethyl and
n represents the degree of polymerization and thus the number of units formed from the at least one dihydroxydiarylalkane by the reaction with the phosgene and on average may have a value of 1 to 6, preferably 1 to 5, particularly preferably 1 to 4, very particularly 1 to 3.

The compounds of the mixture of the reaction product R are very particularly preferably represented by general chemical formula (I) in which
R₁ and R₂ each independently represent H or methyl,
R₃ represents H or (C═O)—Cl,
R₄ represents OH,
X represents isopropylidene or 3,3,5-trimethylcyclohexylidene and
n represents the degree of polymerization and thus the number of units formed from the at least one dihydroxydiarylalkane by the reaction with the phosgene and on average may have a value of 1 to 6, preferably 1 to 5, particularly preferably 1 to 4, very particularly 1 to 3.

Use of bisphenol A as the dihydroxydiarylalkane in the process according to the invention results in preferred mean molar masses Mn (number average) in the range from 352 g/mol (a BPA having two chlorocarbonic acid ester end groups) to 1623 g/mol (n=on average 6) depending on the type of the end groups R₃ and/or R₄ (OH or Cl) of general chemical formula (I). It is in particular preferred when the molar mass is below 1000 g/mol.

It has proven advantageous when the at least one chain terminator is initially well mixed before it can react. The at least one chain terminator is preferably homogeneously distributed. This may be achieved for example by using a static mixer after addition of the at least one chain terminator before said terminator reacts.

It has also proven advantageous when the at least one chain terminator is supplied to the reaction system as an organic phase and not as an aqueous phase.

However, it has been proven advantageous when the at least one chain terminator is added at a pH of 8-11, preferably 9-10. It has been found that at higher pH values (>=11) the distribution of the at least one chain terminator between the organic and aqueous phase becomes disadvantageous. In this case a large proportion is found in the aqueous phase where it cannot react with the chloroformate end groups. It is therefore preferable according to the invention when the process according to the invention comprises no addition of an aqueous alkali metal hydroxide solution before addition of the at least one chain terminator. This is particularly pronounced when the at least one chain terminator comprises phenol. For this reason it is advantageous to add the aqueous alkali metal hydroxide solution only after the addition of the at least one chain terminator.

Despite the small excess of phosgene the process according to the invention enables good phase separation at the end of the reaction and both a low water content in the organic phase and a low residual monomer content in the aqueous phase. Incorporation of catalyst components into the product is also avoided.

Workup comprises leaving the reacted at least biphasic reaction mixture containing at most traces, preferably less than 2 ppm, of chlorocarbonic acid esters to settle for phase separation. The aqueous alkaline phase is optionally completely or partially recycled to the polycarbonate synthesis as aqueous phase or else passed to the wastewater workup where solvent and catalyst fractions are separated and optionally recycled to the polycarbonate synthesis. In another variant of the workup, separation of the organic impurities, in particular solvents and polymer residues, and optionally adjustment to a particular pH, for example by addition of sodium hydroxide solution, is followed by separation of the salt which may be sent for chloralkali electrolysis for example while the aqueous phase is optionally returned to the polycarbonate synthesis.

The organic phase containing the polycarbonate can then be purified in various ways known to those skilled in the art for removal of alkali metal, ionic or catalytic contamination.

Even after one or more settling processes, optionally assisted by passage through settling tanks, stirred tanks, coalescers or separators and/or combinations of these measures—wherein water may optionally be added to each or some separation steps in some cases using active or passive mixing apparatuses—the organic phase generally still contains proportions of the aqueous alkaline phase in fine droplets as well as proportions of the catalyst(s). After this coarse separation of the alkaline aqueous phase the organic phase may be washed one or more times with dilute acids, mineral acids, carboxylic acids, hydroxycarboxylic acids and/or sulfonic acids. Aqueous mineral acids, in particular hydrochloric acid, phosphorus acid, phosphoric acid or mixtures of these acids, are preferred. The concentration of these acids should preferably be in the range 0.001 to 50% by weight, preferably 0.01% to 5% by weight. The organic phase may moreover be subjected to repeated washing with demineralized or distilled water. The separation of the organic phase optionally dispersed with portions of the aqueous phase after the individual washing steps is carried out using settling tanks, stirred tanks, coalescers or separators and/or combinations of these measures, wherein the washing water may be added between the washing steps optionally using active or passive mixing apparatuses. Acids, preferably dissolved in the solvent used in the polymer solution, may optionally be added between these washing steps or else after the washing. Preference is given to using hydrogen chloride gas, phosphoric acid or phosphorous acid and these may optionally also be employed as mixtures. After the last separating operation the thus-obtained purified polycarbonate solution should preferably contain not more than 5% by weight, preferably less than 1% by weight, very particularly preferably less than 0.5% by weight, of water.

Isolation of the polycarbonate from the solution can be effected by evaporation of the solvent using temperature, vacuum or a heated entraining gas. Other isolation methods include for example crystallization and precipitation.

When concentration of the polycarbonate solution and possibly also isolation of the polycarbonate are effected by distillative removal of the solvent, optionally by superheating and expansion, this is referred to as a “flash process”. Such a process is known to those skilled in the art and is described for example in “Thermal Separation Processes”, VCH Verlagsanstalt 1988, p. 114. When instead a spraying of a heated carrier gas together with the solution to be concentrated is undertaken this is referred to as “spray evaporation/spray drying” and described for example in Vauck, “Grundoperationen chemischer Verfahrenstechnik”, Deutscher Verlag für Grundstoffindustrie 2000, 11th edition, p. 690. All of these processes are described in the patent literature and in textbooks and are familiar to those skilled in the art.

Removal of the solvent through temperature (distillative removal) or the technically more effective flash process affords highly concentrated polycarbonate melts. In the flash process polymer solutions are repeatedly heated under light positive pressure to temperatures above the boiling point under atmospheric pressure and these solutions which are superheated relative to atmospheric pressure are then decompressed into a vessel at lower pressure, for example atmospheric pressure. It may be advantageous not to allow the concentration stages, or in other words the temperature stages of the superheating, to become too large but rather to choose a two- to four-stage process.

The residues of the solvent can be removed from the thus-obtained highly concentrated polycarbonate melts either directly from the melt by means of vented extruders (cf. for example BE-A 866 991, EP-A 0 411 510, U.S. Pat. No. 4,980,105, DE-A 33 32 065), thin-film evaporators (cf. for example EP-A 0 267 025), falling-film evaporators, strand evaporators, foam evaporators (for example US 2012/015763 A1) or by friction compaction (cf. for example EP-A 0 460 450), optionally also with addition of an entraining agent, such as nitrogen or carbon dioxide, or using vacuum (cf. for example EP-A 0 039 96, EP-A 0 256 003, U.S. Pat. No. 4,423,207), alternatively also by subsequent crystallization (cf. for example DE-A 34 29 960) and/or baking out the residues of the solvent in the solid phase (cf. for example U.S. Pat. No. 3,986,269, DE-A 20 53 876). These processes too and the apparatuses required therefor are described in the literature and are familiar to those skilled in the art.

Polycarbonate granulates are obtainable—where possible—by direct spinning of the melt and subsequent granulation or else by using discharge extruders from which spinning is effected in air or under liquid, usually water. When extruders are used the polycarbonate melt may be admixed with additives upstream of the extruder, optionally using static mixers or via side extruders in this extruder.

The polycarbonate solution may alternatively be subjected to a spray evaporation. During spraying the optionally heated polycarbonate solution is either jetted into a vessel at negative pressure or jetted with a heated carrier gas, for example nitrogen, argon or steam, into a vessel at atmospheric pressure using a nozzle. In both cases depending on the concentration of the polymer solution powders (dilute) or flakes (concentrated) of the polymer are obtained, from which final residues of the solvent may have to be removed as above. Granulate may subsequently be obtained using a compounding extruder and subsequent spinning. Here too, additives as described hereinabove may be added in the peripheral equipment or to the extruder itself. It may often also be necessary to perform a compacting step for the polymer powder before the extrusion due to the low poured density of the powders and flakes.

The polymer may be largely precipitated from the washed and optionally also concentrated polycarbonate solution by addition of a nonsolvent for polycarbonate. The nonsolvents act as precipitating agents. It is advantageous to first add a small amount of the nonsolvent and optionally also to allow waiting times between additions of the batches of nonsolvent. It may also be advantageous to use different nonsolvents. Employed precipitating agents include for example aliphatic or cycloaliphatic hydrocarbons, in particular heptane, i-octane or cyclohexane, alcohols, for example, methanol, ethanol or i-propanol, ketones, for example, acetone, or mixtures thereof. In the precipitation the polymer solution is generally slowly added to the precipitant. The thus-obtained polycarbonates are processed into granulates as described for spray evaporation and optionally additized.

In other processes precipitation and crystallization products or amorphously solidified products are crystallized in finely divided form by treatment with vapors of one or more nonsolvents for polycarbonate with simultaneous heating below the glass transition temperature and subjected to further condensation to afford higher molecular weights. When oligomers optionally having different terminal groups are concerned (phenolic and chain terminator ends) this is referred to as solid phase condensation.

The addition of additives serves to extend service life or improve color stability (stabilizers), simplify processing (for example mold release agents, flow assistants, antistats) or adjust polymer properties to particular demands (impact modifiers, such as rubbers; flame retardants, colorants, glass fibers).

These additives may be added to the polymer melt individually or in any desired mixtures, together or in a plurality of different mixtures. This may be carried out directly during the isolation of the polymer or else after melting of granulate in a so-called compounding step. The additives or mixtures thereof may be added to the polymer melt as solid, preferably as a powder, or as a melt. Another mode of metered addition is the use of masterbatches or mixtures of masterbatches of the additives or additive mixtures.

Suitable additives are for example described in “Additives for Plastics Handbook, John Murphy, Elsevier, Oxford 1999” and in “Plastics Additives Handbook, Hans Zweifel, Hanser, Munich 2001”.

A further aspect of the invention provides for the use of an energy input of 2.5*e⁶ W/m³ to 5.0*e⁷ W/m³, preferably 3.0*e⁶ W/m³ to 4.0*e⁷ W/m³, particularly preferably of 1.0*e⁷ W/m³ to 3.5*e⁷ W/m³ in a system comprising an organic phase and an aqueous phase, wherein the organic phase contains at least one solvent suitable for the polycarbonate and at least a portion of the phosgene and the aqueous phase contains at least one dihydroxydiarylalkane, water, 1.8 mol to 2.2 mol, preferably 1.95 mol to 2.05 mol, of aqueous alkali metal hydroxide solution per mol of dihydroxydiarylalkane and optionally at least one chain terminator, to reduce the phosgene excess when producing a polycarbonate by the interfacial process. As described hereinabove, the use of this specific energy input preferably also simultaneously results in a reduction in the oligomer proportion in the resulting polycarbonate. Likewise, the use of this specific energy input preferably also simultaneously results in a reduction in the content of di-chain terminator carbonate in the resulting polycarbonate.

It is moreover preferable when the energy input is effected via a disperser. Suitable dispersers are described hereinabove. It is likewise preferable when the process for producing polycarbonate by the interfacial process is performed in continuous fashion. It has proven particularly advantageous that suitable dispersers may simply be installed and/or retrofitted into existing plants. In the use according to the invention it is further preferable when an excess of phosgene relative to the sum of the employed dihydroxydiarylalkanes of 3 to 20 mol %, preferably 4 to 10 mol %, particularly preferably of 5 to 9 mol %, is employed. The examples which follow are intended for exemplary elucidation of the invention and should not be seen as limiting.

### EXAMPLES

The molecular weight distribution and the average values Mn (number-average) and Mw (weight-average) were determined by gel permeation chromatography (GPC). Instrument: Waters “Mixed Bed” columns measurement in methylene chloride as eluent (using BPA homopolycarbonate standard having an Mw of 31 000 g/mol).

In addition to the standing evaluation, the deviation of the GPC from an ideal Schulz-Flory distribution was determined. To this end the GPC was initially normalized to obtain the area below the solid line in the diagram of FIG. 1. This area was normalized to 1. A Schulz-Flory (SF) distribution was also adapted such that it conforms to the measured distribution in terms of both maximum height and molecular weight (dotted line in FIG. 1). The difference between the measured and adapted SF distribution gives the difference distribution (dashed line in FIG. 1). In the present cases the Schulz-Flory distribution is narrower and the difference distribution is thus positive (with the exception of measurement inaccuracies). As a result of the method the difference at the maximum is zero and the difference distribution therefore breaks down into a low-molecular weight portion and a high-molecular weight portion (see also FIG. 1).

It is known from the prior art that a high oligomer proportion is disadvantageous for product quality. However, it is generally only the total proportion of low molecular weight compounds below a certain limit or the proportion soluble in acetone that is considered here. This has the disadvantage of also capturing the unavoidable oligomer proportion which also changes with polycarbonate type (viscosity, Mn). The method of the present invention corrects this correlation and determines only the process-specific oligomer fraction.

In the following, 2,2′-bis(4-hydroxyphenyl)propane (bisphenol A, BPA) was used as the dihydroxydiarylalkane and the solvent of the organic phase was a mixture of about 50% by weight methylene chloride and 50% by weight monochlorobenzene. All examples produced a polycarbonate having the specified weight-average molecular weight measured by GPC (Waters “Mixed Bed” columns in methylene chloride with BPA homopolycarbonate standard having an Mw of 31 000 g/mol).

### Example 1: Reduction of Phosgene Excess

The continuous laboratory tests were performed in a combination of pumps and stirred reactors. In all experiments 70.1 g/h of gaseous phosgene were dissolved in a T-piece in 772 g/h of organic solvent (1:1 methylene chloride/chlorobenzene) at −7° C. The amount of solvent required to ultimately obtain a 15% by weight polycarbonate solution was calculated. The continuously supplied phosgene solution was contacted in a further T-piece with 912 g/h of a 15% by weight aqueous alkaline BPA solution (2 mol of NaOH per mol of BPA) which had been preheated to 30° C. This BPA solution was dispersed in the phosgene solution using a stainless steel filter as a predisperser (pore size 60 μm). In all cases a water-in-oil dispersion was obtained. The energy input reported in table 1 was then generated by a rotor pump.

The reaction mixture was passed into a Fink HMR040 mixing pump which was temperature-controlled to 25° C. so that at the end of the reaction pump phosgene had been converted to the greatest possible extent but was still present. Downstream of this pump in examples 1a, 1c and 1d 3.29 g/h of p-tert-butylphenol were added as chain terminator as a 3% by weight solution in the same solvent mixture as added above and in a further HMR040 pump at 25° C. this reaction mixture was reacted with 53.95 g/h of 32% by weight aqueous sodium hydroxide solution, thus resulting in a pH at the end of the reaction system of about 11.5. In Example 1b 3.29 g/h of p-tert-butylphenol as chain terminator were added as a 3% strength by weight solution in the same solvent mixture as above.

Following in each case were 2 stirred tanks, each having a gear pump from Ismatec. The metered addition of 0.679 g/h of the catalyst (10% by weight of N-ethylpiperidine dissolved in chlorobenzene) in a T-piece in the teflon hose was effected between the two stirred tanks (and gear pumps).

Altogether 156 g of polycarbonate in organic solution were continuously obtained and together with the aqueous phase from the reaction passed to a phase separation vessel to separate said phase. The polycarbonate solution was washed with 10% by weight HCl and dried at standard pressure and room temperature.

Table 1 summarizes the obtained results of example 1:

TABLE 1

| | | | | | | Di-chain | | | |
|---|---|---|---|---|---|---|---|---|---|
| | | | | | Diff. in | terminator | | | |
| | Energy | Phosgene | | | MWD | carbonate | CO3 | Mn | Mw |
| | input | excess | Mn 0 | App. T | (PC) | (PC) | % by | (PC) | (PC) |
| | W/m³ | % | g/mol | ° C. | Area % | ppm | weight | g/mol | g/mol |
| Example 1a | 3.00 * e⁷ | 16.2 | 750 | 35 | 2.72 | <50 | 0.65 | 10580 | 26980 |
| Example 1b | 3.00 * e⁷ | 16.2 | 3470 | 35 | 8.10 | <50 | 0.65 | 7870 | 26160 |
| Example 1c | 3.00 * e⁷ | 9.5 | 660 | 25 | 2.78 | <50 | 0.38 | 9800 | 26200 |
| Example 1d | 3.00 * e⁷ | 7 | 730 | 25 | 2.50 | <50 | 0.33 | 9990 | 25300 |

Mn0: Molecular weight at addition of chain terminator
Diff. in MWD (PC): Difference distribution; see above

Example 1a shows that a high energy input in process step (a) makes it possible to obtain a polycarbonate having a low content of oligomers and di-chain terminator carbonate. In Example 1b the chain terminator was added later.

Inventive examples 1c and 1d show that a high energy input also makes it possible to reduce the phosgene excess. At the same time a polycarbonate having good or even improved content of oligomers and di-chain terminator carbonate is obtained. In Example 1b the addition of NaOH is effected at an earlier juncture than the addition of chain terminator. Nevertheless, the addition of the chain terminator was effected at such an early juncture that it is assumed that phosgene remains in the reaction system.

The addition of the chain terminator at a juncture at which no phosgene remains in the reaction system would mean that the reaction product R on average has an even higher molecular weight. An even higher proportion of oligomers would therefore be expected.

### Example 2

The apparatuses employed for the individual process steps are as follows:
Process step (A): Disperser in the form of a perforated plate nozzle with a predisperser (having a perforated plate having 5 bores, each of 2.5 mm in diameter, at a thickness of the perforated plate of 2.35 and a pressure drop of 0.2 bar at a flow rate of 5.2 m/s), 26 ms residence time in the predispersing space (in examples 2a and 2b the aqueous phase was dispersed in the organic phase by the predisperser; in comparative example 2c the organic phase was dispersed in the aqueous phase by the predisperser) and subsequent dispersing (with a further perforated plate having 18 bores, each of 1.5 mm in diameter, at a thickness of the perforated plate of 2.35 mm and a pressure drop of 0.8 bar at a flow rate of 8.9 m/s in comparative example 2c (this corresponds to example 1 of DE102008012613 A1; having a further perforated plate having 18 bores, each of 1.0 mm in diameter, at a thickness of the perforated plate of 2.35 mm and a pressure drop of 0.8 bar at a flow rate of 8.9 m/s in the inventive examples 2a and 2b) through which one liquid is dispersed in the other.
Process step (B): A dwell time reactor having a residence time of 0.2s at 600 kg/h (bisphenol solution).
Process step (C): A pumped-circulation reactor fitted with a metered addition point (for example for NaOH), a pump, a heat exchanger, an overflow vessel and a T-shaped withdrawal point having a volume of 140 l, fitted with a pH probe and a conductivity probe; redispersion is effected upon entry into the pumped-circulation reactor; in example 2a the chain terminator is added into the pumped-circulation reactor.
Process step (D): A discharge pump with upstream metered addition points for chain terminators (in example 2b and comparative example 2c the chain terminator is added here; in example 2a nothing is added here) and NaOH solution, a static mixer therebetween, downstream thereof a helical tube reactor having mixing and dwell zones and a total volume of 60 l (first dwell reactor) and downstream thereof a further helical tube reactor (second dwell reactor) with a metered addition point for catalyst at the beginning of the reactor and a total volume of 80 l.
Subsequent phase separation: Separation vessel (size 4.15 m³ at a fill level of 50%).

The following material streams were used in process step (A):
500 kg/h aqueous bisphenol solution (15% by weight of a mixture of bisphenol A and bisphenol TMC based on the total weight of the solution, 2.13 mol NaOH/mol bisphenol solution) in examples 2a and 2b (the phosgene stream and the stream of the solvent mixture (see below) were scaled according to the reduced bisphenol flow)
or
600 kg/h aqueous bisphenol solution (15% by weight bisphenol A based on the total weight of the solution, 2.13 mol NaOH/mol bisphenol solution) in comparative example 2c
44.6 kg/h phosgene
520 kg/h solvent mixture composed of 54% by weight methylene chloride and 46% by weight chlorobenzene

No further material streams were additionally used in process step (B) and (C).

In process step (D) the following material streams were additionally employed upstream of the first dwell reactor:
17.8 kg/h t-butylphenol solution (20% by weight, in a solvent mixture of 54% by weight methylene chloride and 46% by weight chlorobenzene)
35 kg/h aqueous NaOH solution with 32% by weight NaOH

In process step (D) the following material stream was additionally employed in the second dwell reactor:
22.7 kg/h catalyst solution (3% by weight solution, ethyl piperidine in a solvent mixture of 54% by weight methylene chloride and 46% by weight chlorobenzene)

The temperature in the pumped-circulation reactor was between 35° C. (downstream of the heat exchanger) and 38° C. (upstream of the heat exchanger). The temperature in the helical tube reactors in process step (D) was 37° C. in each case and in the separation vessel was 35° C.

The dispersion direction was set such that the organic phase was dispersed in the aqueous phase.

Table 2 summarizes the obtained results.

TABLE 2

| | | | | | | Di-chain | | | |
|---|---|---|---|---|---|---|---|---|---|
| | | | | | | terminator | | | |
| | Energy | | Mn | | Diff. in | carbonate | CO3 | Mn | Mw |
| | input | | Loop | App. T | MWD | (PC) | % by | (PC) | (PC) |
| | W/m³ | Dispersion | g/mol | ° C. | Area % | ppm | weight | g/mol | g/mol |
| Example 2a | 4.2 * e⁶ | wo | <900* | 60 | 3.50 | 200 | 0.75 | 12020 | 31650 |
| Example 2b | 4.2 * e⁶ | wo | 2320 | 60 | 5.00 | <20 | 0.76 | 10240 | 29026 |
| Comparative | 1.2 * e⁶ | ow | 2210 | 50* | 6.20 | <50 | 0.64 | 8750 | 24450 |
| example 2c | | | | | | | | | |

*estimated value
MnLoop: Molecular weight at addition of chain terminator
Diff. in MWD (PC): Difference distribution; see above

In examples 2a and 2b a phosgene excess of 19% was employed. In comparative example 2c a phosgene excess of 15% was employed. Since the bisphenol solution of the comparative example has a different composition than that of the inventive examples an adjustment of the phosgene excess was necessary.

It is nevertheless apparent that as a result of the energy input disclosed in the examples of DE 10 2008 012 613 A1 a polycarbonate having a relatively high oligomer proportion is obtained. By increasing the energy input (inventive examples 2a and 2b) this proportion can be reduced while maintaining an acceptable di-chain terminator carbonate content. As a result of the different energy inputs a water-in-oil dispersion is present in process step (a) in the inventive examples 2a and 2b while an oil-in-water dispersion was present in comparative example 2c. In these examples too it is apparent that the juncture of addition of the chain terminator entails further advantages in terms of the content of oligomers and di-chain terminator carbonate.

1. A continuous process for producing polycarbonate by the interfacial process from at least one dihydroxydiarylalkane, phosgene, at least one catalyst and at least one chain terminator comprising the steps of
(a) generating a dispersion from an organic phase and an aqueous phase by continuously dispersing the organic phase in the aqueous phase or the aqueous phase in the organic phase in a disperser, wherein the organic phase contains at least one solvent suitable for the polycarbonate and at least a portion of the phosgene and the aqueous phase contains the at least one dihydroxydiarylalkane, water and 1.8 mol to 2.2 mol of aqueous alkali metal hydroxide solution per mol of dihydroxydiarylalkane,
(b) adding at least one chain terminator to the dispersion from step (a) and
(c) adding at least one catalyst to the mixture obtained from step (b),
wherein the energy input by the disperser in step (a) is 2.5*e⁶ W/m³ to 5.0*e⁷ W/m³.

2. The continuous process as claimed in claim 1, wherein process step (a) comprises producing a water-in-oil dispersion.

3. The continuous process as claimed in claim 1, wherein the process comprises a step of one or more additions of an aqueous alkali metal hydroxide solution.

4. The continuous process as claimed in claim 3, wherein the adding of the at least one chain terminator to the reaction system in process step (b) is performed at a juncture prior to the first of the one or more additions of the aqueous alkali metal hydroxide solution.

5. The continuous process as claimed in claim 1, wherein in process step (a) an excess of phosgene relative to the sum of the employed dihydroxydiarylalkanes of 3 to 20 mol % is present.

6. The continuous process as claimed in claim 1, wherein the at least one catalyst is selected from the group consisting of a tertiary amine and an organophosphine.

7. The continuous process as claimed in claim 1, wherein the at least one chain terminator is selected from the group consisting of phenol, alkylphenols and chlorocarbonic acid esters thereof or acid chlorides of monocarboxylic acids.

8. The continuous process as claimed in claim 1, wherein the at least one dihydroxydiarylalkane is selected from the group consisting of 4,4′-dihydroxydiphenyl, 1,1-bis(4-hydroxyphenyl)phenylethane, 2,2-bis(4-hydroxyphenyl)propane, 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane and any desired mixtures thereof.

9. The continuous process as claimed in claim 1, wherein at least one nozzle, pipe baffle, static mixer, pump and/or jet disperser is used as the disperser in process step (a).

10. The continuous process as claimed in claim 1, wherein in process step (b) the at least one chain terminator is introduced into the reaction system comprising at least the at least one dihydroxydiarylalkane, the phosgene and the reaction product R of the at least one dihydroxydiarylalkane and the phosgene at a juncture at which the reaction product R is a mixture of compounds and these compounds on average have a degree of polymerization of at least one unit and at most six units formed from the at least one dihydroxydiarylalkane by the reaction with the phosgene.

11. The continuous process as claimed in claim 10, wherein the compounds of the mixture of the reaction product R are represented by the general chemical formula (I): 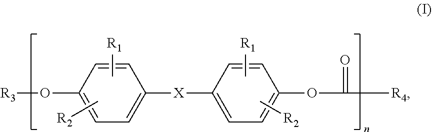
in which
R₁ and R₂ independently represent H, C1 to C18 alkyl, C1 to C18 alkoxy, halogen such as Cl or Br or in each case optionally substituted aryl or aralkyl,
R₃ represents H, (C═O)—Cl or (C═O)—OH,
R₄ represents OH or Cl,
X represents a single bond, —SO₂—, —CO—, —O—, —S—, C1 to C6 alkylene, C2 to C5 alkylidene or C5 to C6 cycloalkylidene, which may be substituted by C1 to C6 alkyl, or else represents C6 to C12 arylene,
n represents the degree of polymerization and thus the number of units formed from the at least one dihydroxydiarylalkane by the reaction with the phosgene and on average may have a value of 1 to 6.

12. A method comprising reducing a phosgene excess using an energy input of 2.5*e⁶ W/m³ to 5.0*e⁷ W/m³ in a system comprising an organic phase and an aqueous phase, wherein
the organic phase contains at least one solvent suitable for the polycarbonate and at least a portion of the phosgene and
the aqueous phase contains at least one dihydroxydiarylalkane, water, and 1.8 mol to 2.2 mol of aqueous alkali metal hydroxide solution per mol of dihydroxydiarylalkane,
to reduce the phosgene excess when producing a polycarbonate by the interfacial process.

13. The method as claimed in claim 12, wherein the energy input is effected via a disperser.

14. The method as claimed in claim 12, wherein the process for producing polycarbonate by the interfacial process is performed in continuous fashion.

15. The method as claimed in claim 12, wherein an excess of phosgene relative to the sum of the employed dihydroxydiarylalkanes of 3 to 20 mol % is employed.

16. The continuous process as claimed in claim 1, wherein the aqueous phase in step (a) contains the at least one dihydroxydiarylalkane, water and 1.95 mol to 2.05 mol of aqueous alkali metal hydroxide solution per mol of dihydroxydiarylalkane.

17. The continuous process as claimed in claim 1, wherein the energy input by the disperser in step (a) is 1.0*e⁷ W/m³ to 3.5*e⁷ W/m³.

18. The method as claimed in claim 12, wherein the method comprises reducing a phosgene excess using an energy input of 1.0*e⁷ W/m³ to 3.5*e⁷ W/m³.

19. The method as claimed in claim 12, wherein the aqueous phase contains at least one dihydroxydiarylalkane, water, 1.8 mol to 2.2 mol-of aqueous alkali metal hydroxide solution per mol of dihydroxydiarylalkane and at least one chain terminator.

20. The continuous process as claimed in claim 11, wherein R₁ and R₂ independently represent H or methyl.
